(19) United States
(12) Patent Application Publication
(10) Pub. No.: US 2026/0247177 A1
(43) Pub. Date: Aug. 20, 2026

(54) METHOD AND SYSTEM FOR OPTIMIZING A WIRELESS INTERCONNECTION NETWORK FOR AN ULTRA-HIGH PERFORMANCE COMPUTING SYSTEM

(71) Applicant: KOREA UNIVERSITY RESEARCH AND BUSINESS FOUNDATION, Seoul (KR)

(72) Inventors: Sang Hyun LEE, Seoul (KR); Young Chai KO, Seoul (KR); Hee Soo KIM, Seoul (KR); Yong Hun JANG, Seoul (KR); Hong Ki KIM, Gwangju-si (KR); Gun KIM, Daejeon (KR)

(21) Appl. No.: 19/529,960

(22) Filed: Feb. 4, 2026

(30) Foreign Application Priority Data
Feb. 19, 2025 (KR) 10-2025-0021716
Jan. 27, 2026 (KR) 10-2026-0016296

(51) Int. Cl. H04W 24/02; H04B 7/04; H04W 24/08

(52) U.S. Cl. CPC H04W 24/02; H04B 7/04013; H04W 24/08

(57) ABSTRACT

A method and system for optimizing a wireless interconnection network for a high-performance computing (HPC) system are disclosed. The wireless interconnection network system includes a plurality of wireless transceivers; a plurality of intelligent reconfigurable reflecting surface units; a telemetry module configured to collect link-quality measurements for the plurality of wireless transceivers and the plurality of intelligent reconfigurable reflecting surface units; a digital twin engine configured to update, based on the link-quality measurements, a link state of a digital twin environment modeling an HPC environment and to output, to satisfy communication requirements according to a distribution plan for application tasks, parameters of the wireless transceivers and parameters of the intelligent reconfigurable reflecting surface units; and a network controller configured to control the plurality of wireless transceivers and the plurality of intelligent reconfigurable reflecting surface units based on the parameters output from the digital twin engine.

### CROSS-REFERENCE TO RELATED APPLICATION

This application claims the benefit of priority under 35 U.S.C. § 119(a) to Korean Patent Application No. 10-2025-0021716, filed on February 19, 2025, and Korean Patent Application No. 10-2026-0016296, filed on January 27, 2026, the entire contents of which are incorporated herein by reference.

### BACKGROUND

### Technical Field

The present disclosure relates to a method and system for optimizing a wireless interconnection network for an ultra-high performance computing system.

### Background Art

High-performance computing (HPC) systems are advanced systems that combine a large number of central processing units (CPUs) with other accelerator devices to perform complex computations in parallel, playing an essential role in science and technology research such as nanoscale analysis, weather forecasting, and large-scale data processing. Recently, with the rapid growth of mega data centers (MDCs) and large-scale AI applications, HPC has become an indispensable resource for large-scale computation. In particular, as AI-dedicated HPC systems equipped with high-performance compute accelerators such as GPUs have emerged, the importance of HPC in supporting high-speed computation has further increased.

To address the continuously increasing demand for data processing, leading science and technology-advanced countries are mobilizing national capabilities to deploy exascale (10¹⁸ operations per second) HPC. For example, in 2022, the United States achieved the world’s first performance exceeding 1 exaflop, reaching 1.102 exaflops with the Frontier system, and many other countries, including Korea, are also pursuing the introduction of high-performance HPC to narrow the performance gap and advance domestic science and technology research. As of 2023, Korea faces a gap of more than approximately 36 times compared to the world’s highest performance, and an innovative HPC deployment strategy is urgently required to reduce this gap.

In HPC, compute nodes exchange large amounts of data and control signals and use a communication network referred to as an “interconnect” to perform parallel computation. In current HPC systems that require high-speed data transmission and reliability, wired network technologies such as gigabit ethernet and infiniband are predominantly used. However, as the number of nodes increases to scale performance to the exascale level and beyond, the interconnect topology/connection strategy and its performance become major factors that significantly affect the overall performance of the HPC system.

In conventional fixed interconnect topologies, a large number of cables must be used to increase high-speed link density, which leads to limitations in terms of physical integration density and cost.

An HPC system is configured in a hierarchical structure in which multiple compute units are interconnected (unit → node → rack → cluster), where each compute unit includes basic computing resources such as a CPU and memory. To meet the requirements for high-performance computation, heterogeneous CPU/GPU coupled systems that integrate accelerator hardware such as GPUs have recently been introduced, thereby enabling a structure capable of high-speed computation. Compute nodes and racks are interconnected via the interconnect to form a compute cluster, which operates as an independent network and supports parallel processing.

Representative approaches used to improve HPC performance include “scale-up,” which enhances the performance of an individual compute unit, and “scale-out,” which expands the number of interconnected compute nodes to maximize parallel processing. Recently, as silicon semiconductor technology has approached physical limits, the scale-out approach has been predominantly adopted to satisfy the rapidly growing computational demands of AI applications, and accordingly the interconnect configuration and performance have become even more critical factors for overall HPC performance.

Interconnect network topologies include fat-tree, torus, and dragonfly, and the performance efficiency of each topology varies depending on application characteristics. According to recent studies, high performance can be achieved by dynamically configuring the interconnect by selecting, in real time, one of multiple application-optimized topologies, or by adopting a hybrid topology approach that adds new links between physically distant nodes. To this end, scalable interconnect technology is required that can flexibly configure topologies in real time via wireless interconnects and support application-optimized connectivity schemes.

Conventional high-performance computing (HPC) systems perform data transmission between compute nodes via wired interconnects. However, such wired approaches require high-density cable deployment and, due to physical constraints on routing and connection space, exhibit limitations in system scalability. This becomes a serious issue particularly for next-generation HPC systems targeting exascale-level performance or beyond, making it difficult to realize a flexible and scalable network configuration for large-scale compute clusters.

### SUMMARY OF THE DISCLOSURE

The present disclosure is directed to provide a method and a system for optimizing a wireless interconnection network for an ultra-high performance computing system.

The present disclosure is also directed to providing a method and a system for optimizing a wireless interconnection network for an HPC system, which enables a flexible and scalable interconnection configuration for exascale-or-beyond HPC systems by overcoming spatial limitations of conventional wired interconnection schemes.

The present disclosure is also directed to providing a method and a system for optimizing a wireless interconnection network for an HPC system, which can build a high-performance dynamic compute cluster by increasing topology flexibility while minimizing inter-node interference, and can satisfy performance requirements in large-scale HPC systems.

The present disclosure is also directed to providing a method and a system for optimizing a wireless interconnection network for an HPC system, which enables stable data transmission without interfering with neighboring nodes by applying wireless beamforming and intelligent reflecting surface technologies, provides adaptability to dynamic topology changes and configuration, maximizes connection efficiency in a large-scale system, facilitates optimal path configuration and autonomous network reconfiguration, and thereby allows easy addition of new nodes and system scaling to secure high-efficiency flexibility.

The present disclosure is also directed to providing a method and a system for optimizing a wireless interconnection network for an HPC system, which enables real-time bidirectional control and thereby performs benchmark performance evaluation and optimization across various compute-cluster configurations, and secures scalability and reliability essential for post-exascale HPC systems by providing cloud management and autonomous network-operation tools, while offering broad applicability to various large-scale application environments.

According to one aspect of the present disclosure, a wireless interconnection network system for a high-performance computing (HPC) system is provided.

According to an embodiment of the present disclosure, the wireless interconnection network system may include: a plurality of wireless transceivers attached to at least one of a plurality of racks and a plurality of compute nodes, wherein the plurality of racks are disposed in a machine room space and accommodate the plurality of compute nodes for high-performance computing; a plurality of intelligent reconfigurable reflecting surface units disposed on at least one of a ceiling of the machine room space, the racks, and a wall surface; a telemetry module configured to collect link-quality measurements for the plurality of wireless transceivers and the plurality of intelligent reconfigurable reflecting surface units; a digital twin engine configured to update a link state of a digital twin environment modeling the high-performance computing environment based on the collected link-quality measurements, generate virtual candidate communication-link configurations to satisfy communication requirements according to a distribution plan for an application task in the digital twin environment, perform virtual simulations on the virtual candidate communication-link configurations to select an optimal communication-link configuration, and output wireless-transceiver parameters and parameters of the intelligent reconfigurable reflecting surface units corresponding to the selected optimal communication-link configuration; and a network controller configured to adjust the plurality of wireless transceivers and the plurality of intelligent reconfigurable reflecting surface units based on the parameters output from the digital twin engine, wherein each of the plurality of virtual candidate communication link configurations includes at least one of (i) a line-of-sight (LoS) direct communication link between wireless transceivers or (ii) a non-line-of-sight (NLoS) reflective communication link using the intelligent reconfigurable reflecting surface units.

The digital twin engine may distribute the application tasks on a per-cluster basis, generate a distribution plan that assigns distributed tasks to the plurality of compute nodes within each cluster, and generate a plurality of the virtual candidate communication link configurations based on a traffic matrix or communication requirements representing inter-node data-exchange demands based on the distribution plan, wherein each of the virtual candidate communication link configurations may include a combination of a transmit-side wireless transceiver and a receive-side wireless transceiver among the plurality of wireless transceivers.

The digital twin engine may perform a virtual simulation on the virtual candidate communication link configurations under constraint conditions and evaluate the virtual candidate communication link configurations based on an objective function to select the optimal communication link configuration, wherein the constraint conditions may include: (i) an interference threshold; (ii) a limit on the number of concurrent links and an availability constraint on resources of the wireless transceivers and the intelligent reconfigurable reflecting surface units; (iii) a non-overlapping panel-allocation constraint that prevents, in the same control interval, the same intelligent reconfigurable reflecting surface unit from being simultaneously allocated to two or more non-line-of-sight (NLoS) reflective communication links; and (iv) an upper bound on the number of links that can be simultaneously served per intelligent reconfigurable reflecting surface unit, and wherein the objective function may include at least one of latency, tail latency, congestion, a signal-to-noise ratio (SNR), a packet error rate, throughput, energy consumption, or a wireless- link reconfiguration cost.

The network controller may, when the optimal communication link configuration includes a line-of-sight (LoS) direct communication link, adjust at least one of transmit power, a center frequency, bandwidth, a modulation and coding scheme (MCS), antenna-array weights, a beam direction, or a beamwidth based on the wireless-transceiver parameters, and, when the optimal communication link configuration includes an NLoS reflective communication link, adjust a reflection parameter including at least one of a unit-cell-level phase setting or a unit-cell-level amplitude setting of the intelligent reconfigurable reflecting surface units.

The LoS direct communication link and the NLoS reflective communication link may be formed in at least one frequency band among an mmWave band, a sub-THz band, a THz band, or a free-space optical (FSO) band, wherein, when the frequency band includes the FSO band, the intelligent reconfigurable reflecting surface units may include an optical reflective metasurface device, and the network controller may dynamically control an angle of the wireless transceivers and an angle of the optical reflective metasurface device for optical-path alignment.

The digital twin engine and the network controller may operate control cycles in a multi-layer manner, wherein, in a first control cycle, beam parameters are finely adjusted in units of microseconds (µs) to milliseconds (ms), wherein, in a second control cycle, communication link configurations are re-arranged in units of minutes, and wherein, in a third control cycle, the constraint conditions and the objective function are updated in units of hours or days by reflecting a cooling constraint and/or an environmental state.

The digital twin engine may receive event information including at least one of maintenance work in the machine room space, cage opening/closing, cage temperature, placement of mobile equipment, or occurrence of a temporary obstacle, and may apply a penalty, based on the event information, to candidate communication link configurations that are expected to experience link blockage or performance degradation, thereby selecting the optimal communication link configuration.

The digital twin engine may calculate an error between link-quality measurements collected from the telemetry module and link-performance indicators predicted by the virtual simulation, update the link state of the digital twin environment by calibrating at least one of channel-model parameters, interference-model parameters, or reflection-model parameters in the digital twin environment such that the error is minimized, and wherein the link-performance indicators may include at least one of an SNR, a packet error rate, throughput, or latency.

The digital twin engine may generate or receive a task graph from the distribution plan and jointly optimize the distribution plan and selection of the optimal communication link configuration based on task precedence relationships and inter-task communication volume and/or communication frequency using the task graph.

The digital twin engine may, when link-quality measurements collected from the telemetry module after application of the optimal communication link configuration fall below a preset performance criterion or when a link-disconnection event is detected, select a backup communication link configuration stored in advance or a second-best communication link configuration among the virtual candidate communication link configurations and provide the selected configuration to the network controller, thereby enabling a fast switching (fallback or hand-over) between the LoS direct communication link and the NLoS reflective communication link.

The digital twin engine may, based on baseline placement information of the wireless transceivers and the intelligent reconfigurable reflecting surface units, perform beam pre-training for a plurality of beam candidates to generate a beam codebook and a list of link candidates, estimate beam-alignment error through self-calibration based on at least one of a pilot signal or integrated sensing and communication (ISAC) to calculate a correction value, and reflect the correction value as an initial value and/or a constraint condition for at least one of the wireless-transceiver parameters or the intelligent reconfigurable reflecting surface unit parameters.

According to another aspect of the present disclosure, a method for optimizing a wireless interconnection network for a high-performance computing system is provided.

According to an embodiment of the present disclosure, a method for optimizing a wireless interconnection network in a high-performance computing (HPC) environment may include: (a) collecting link quality measurements for a plurality of compute nodes accommodated in a plurality of racks in a machine room space, a plurality of wireless transceivers attached to the racks, and a plurality of intelligent reconfigurable reflecting surface units disposed on at least one of a ceiling of the machine room space, the racks, or a wall surface; (b) updating, using the link quality measurements, a link state of a digital twin environment that models the HPC environment; (c) generating, in the digital twin environment, a distribution plan for application tasks, and generating a plurality of virtual candidate communication link configurations to satisfy communication requirements according to the distribution plan; (d) performing virtual simulation for the virtual candidate communication link configurations to select an optimal communication link configuration, and outputting wireless transceiver parameters and parameters of the intelligent reconfigurable reflecting surface units corresponding to the selected optimal communication link configuration; and (e) configuring a communication link by adjusting the wireless transceivers and the intelligent reconfigurable reflecting surface units based on the output parameters, wherein each of the virtual candidate communication link configurations includes at least one of (i) a line-of-sight (LoS) direct communication link between wireless transceivers or (ii) a non-line-of-sight (NLoS) reflected communication link using the intelligent reconfigurable reflecting surface units.

In the step (d), the virtual candidate communication link configurations may be evaluated by performing the virtual simulation on each of the virtual candidate communication link configurations under constraint conditions, wherein the constraint conditions may include: (i) an interference threshold; (ii) a limit on the number of concurrent links and an availability constraint on resources of the wireless transceivers and the intelligent reconfigurable reflecting surface units; (iii) a non-overlapping panel-allocation constraint that prevents, in the same control interval, the same intelligent reconfigurable reflecting surface unit from being simultaneously allocated to two or more NLoS reflective communication links; and (iv) an upper bound on the number of links that can be simultaneously served per intelligent reconfigurable reflecting surface unit, and wherein an objective function may include at least one of latency, tail latency, congestion, an SNR, a packet error rate, throughput, energy consumption, or a wireless-link reconfiguration cost.

Before the step (b) or in parallel with the step (b), the method may further include: generating a beam codebook and a list of link candidates by performing beam pre-training for a plurality of beam candidates based on baseline placement information of the wireless transceivers and the intelligent reconfigurable reflecting surface units; calculating a correction value by estimating beam-alignment error through self-calibration based on a pilot signal and/or integrated sensing and communication (ISAC); and reflecting the correction value as an initial value and/or a constraint condition for the wireless-transceiver parameters and/or the intelligent reconfigurable reflecting surface unit parameters.

### BRIEF DESCRIPTION OF DRAWINGS

FIG. 1 is a diagram illustrating an overall system of a wireless interconnection network for a high-performance computing environment according to an embodiment of the present disclosure.

FIG. 2 is a diagram illustrating a high-performance computing environment according to an embodiment of the present disclosure.

FIG. 3 is a diagram illustrating a wireless interconnection network system for a high-performance computing environment according to an embodiment of the present disclosure.

FIG. 4 is a diagram illustrating, in a digital twin environment, a housing configuration and an example of reflected wireless link utilities derived therefrom according to an embodiment of the present disclosure.

FIG. 5 is a flowchart illustrating a method of optimizing a wireless interconnection network in a high-performance computing environment according to an embodiment of the present disclosure.

FIG. 6 is a diagram illustrating, together with a wireless link testbed and a pilot compute-node platform, a process of evaluating link coordination results and performance of a virtual high-performance computing system in a digital twin environment according to an embodiment of the present disclosure.

### DETAILED DESCRIPTION

Singular forms used in this specification include plural forms unless the context clearly indicates otherwise. In the specification, the term “configured”, “include”, or the like should not be construed as necessarily including several components or several steps described herein, in which some of the components or steps may not be included or additional components or steps may be further included. Further, the terms “~ unit”, “module”, and the like mean a unit for processing at least one function or operation and may be implemented by hardware or software or by a combination of hardware and software.

Hereinafter, the embodiments of the present disclosure will be described in detail with reference to the accompanying drawings.

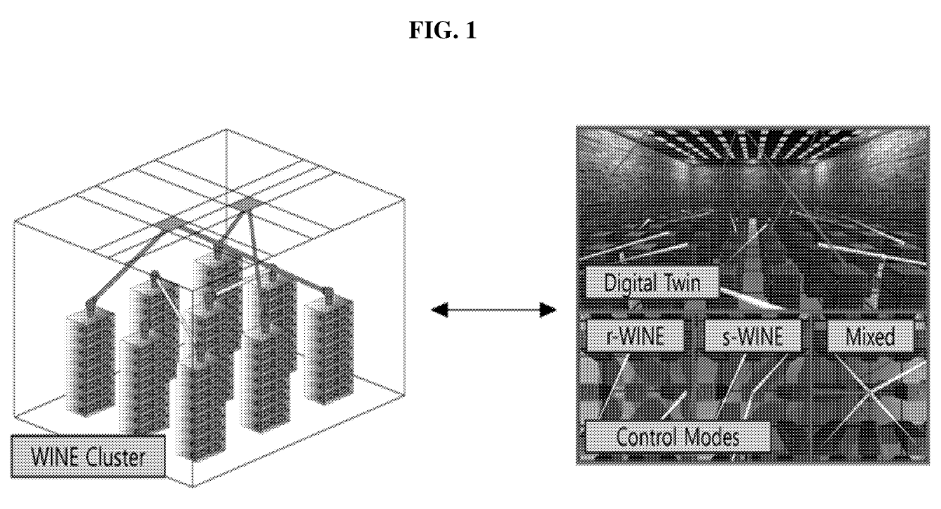

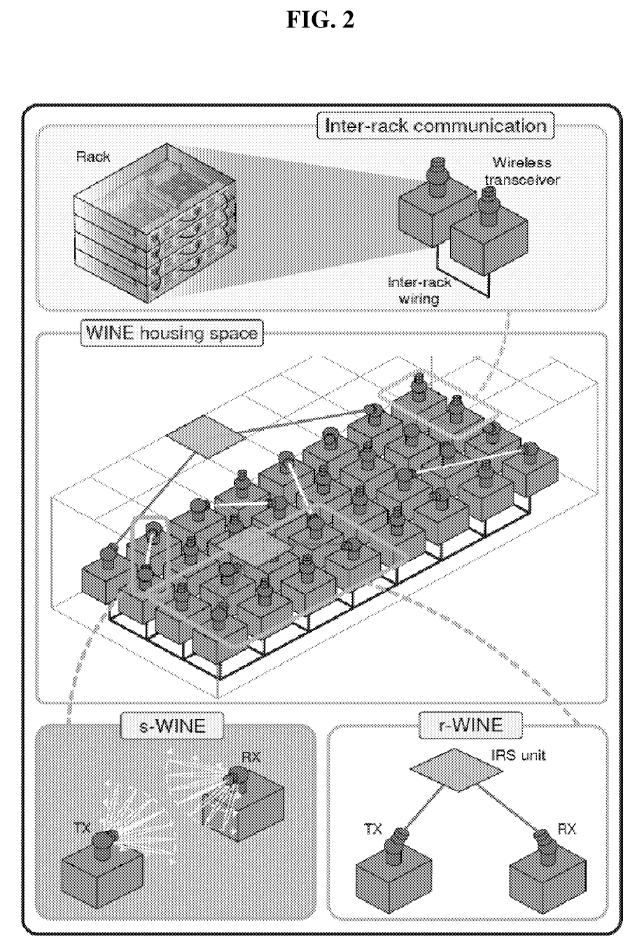

FIG. 1 is a diagram illustrating an overall system of a wireless interconnection network for a high-performance computing environment according to an embodiment of the present disclosure, and FIG. 2 is a diagram illustrating a high-performance computing environment according to an embodiment of the present disclosure.

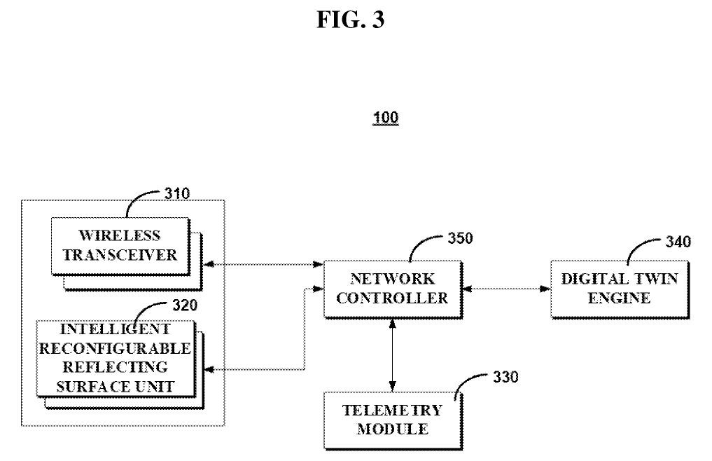

The overall system may be configured in a closed-loop structure in which a physical high-performance computing system and a digital twin environment virtually modeling the physical high-performance computing system interoperate with each other. Referring to FIGS. 1 and 2, the high-performance computing system may include a plurality of racks disposed in a machine room space (for example, an electromagnetically shielded chamber) and a plurality of compute nodes accommodated in the racks. Each compute node may include computing components, such as a processor (CPU), a dedicated memory, and an accelerator such as a graphics processing unit (GPU). The compute nodes may be densely arranged within the racks, as shown in FIG. 2, for space efficiency, management, and cooling. The high-performance computing system may further include a wired interconnect (for example, inter-rack cabling and switch paths) providing baseline connectivity between the racks. Further, as will be described in more detail below, the high- performance computing system may include a wireless interconnect, which will be described in detail with reference to FIG. 3 below.

According to an embodiment of the present disclosure, the system may perform a function of generating virtual candidate interconnection configurations and evaluating performance by modeling a physical deployment of the physical high-performance computing system (for example, locations of racks, wireless transceivers, and intelligent reconfigurable reflecting surface units), channel characteristics, interference characteristics, reflection characteristics, and a configurable scope of wired and wireless interconnects. For example, the digital twin environment may generate candidate configurations according to an application workflow (e.g., a task graph, a traffic matrix, and latency requirements), and may predict performance metrics, such as latency, tail latency, throughput, congestion, and packet error rate, for each candidate configuration through virtual simulation, thereby selecting an optimal interconnection configuration with a high workflow satisfaction level. This will be described in more detail below.

According to an embodiment of the present disclosure, the physical high-performance computing system and the digital twin environment may be bidirectionally coupled. For example, the digital twin environment may perform workload distribution simulation for an application assigned to the high-performance computing system to improve placement and utilization efficiency of computing resources, and may determine a configuration of the wireless interconnect (for example, selection of wireless links and parameter settings for link establishment direction and alignment) based on simulation results and link-state prediction results. In addition, link quality measurements or operational event information collected from the physical high-performance computing system may be fed back to the digital twin environment to update a link state of the digital twin environment, and control results derived based on the updated link state may be applied back to the physical high-performance computing system. Accordingly, an interconnection configuration suitable for the application workflow may be continuously maintained.

Hereinafter, the configuration and operation of the wireless interconnection network system for the high-performance computing environment will be described in more detail with reference to FIG. 3.

FIG. 3 is a diagram illustrating a wireless interconnection network system for a high-performance computing environment according to an embodiment of the present disclosure.

Referring to FIG. 3, a wireless interconnection network system 100 for a high-performance computing environment according to an embodiment of the present disclosure includes a plurality of wireless transceivers 310, a plurality of intelligent reconfigurable reflecting surface (IRS) units 320, a telemetry module 330, a digital twin engine 340, and a network controller 350.

The plurality of wireless transceivers 310 are attached to racks or compute nodes and perform wireless communication for data exchanges among the compute nodes. For example, each wireless transceiver 310 may form a beam for a line-of-sight (LoS) direct communication link and/or a non-line-of-sight (NLoS) reflected communication link based on at least one wireless transceiver parameter among transmit power, a center frequency, bandwidth, a modulation and coding scheme (MCS), antenna array weights, a beam direction, and a beamwidth.

Although the wireless transceivers 310 may be arranged such that LoS direct communication links are formed between the wireless transceivers 310, in an actual machine room space, LoS between some transceivers may be blocked due to dense rack arrangements, cage structures, mobile equipment, and maintenance operations, or interference between adjacent links may increase. Accordingly, the system according to an embodiment of the present disclosure may further include the IRS units 320 to increase the degrees of freedom for wireless link configuration.

The plurality of IRS units 320 may be disposed on at least one of a ceiling of the machine room space, a rack, or a wall surface and may be configured to form NLoS reflected communication links by providing reflection paths even when links between the wireless transceivers 310 are in an NLoS environment or exhibit high interference/shielding. The IRS units 320 may have reflection parameters including unit-cell-level phase and/or amplitude settings, and the reflection characteristics may be dynamically adjusted under control of the network controller 350.

According to an embodiment of the present disclosure, the high-performance computing (HPC) environment may transmit and receive data using a plurality of wireless communication links as well as wired links. Among the plurality of wireless communication links, one may be a LoS direct communication link between wireless transceivers, and another may be a NLoS reflected communication link.

As illustrated in FIG. 2, an LoS direct link may be configured through beamforming between a transmitting wireless transceiver and a receiving wireless transceiver, and a reflected link may be configured through a communication path of a transmitting wireless transceiver (an IRS unit) a receiving wireless transceiver. Such LoS direct communication links and NLoS reflected communication links may be utilized to bypass congested sections of wired communication links or to expand link availability.

Since the physical structure and link states of the HPC environment have been basically described with reference to FIG. 2, in the present specification, the HPC environment may refer to a communication infrastructure environment including: a plurality of racks disposed in a machine room space and a plurality of compute nodes accommodated in the racks, a plurality of wireless transceivers attached to the racks and/or the compute nodes, a plurality of IRS units disposed on at least one of a ceiling/a rack/a wall surface of the machine room space, and wired links connecting the racks. Further, the HPC environment should be understood to include an environment in which LoS conditions and interference conditions of wireless links may vary over time due to dense rack arrangements, cage structures, ducts/cabling, and variable obstacles caused by maintenance operations.

The telemetry module 330 may collect link-quality measurements associated with the wireless transceivers 310 and/or the IRS units 320. For example, the link-quality measurements may include at least one of a signal-to-noise ratio (SNR), a packet error rate, throughput, latency, a congestion metric, and a link-disconnection event, and a collection period and measurement items may be variously set depending on implementation.

The digital twin engine 340 may model a digital twin environment for the HPC environment. In a compact HPC system housing space (machine room space), dense wireless connectivity may be affected by shielding caused by physical obstacles such as racks, cages, and cooling facilities, and by mutual interference among wireless signals. According to an embodiment of the present disclosure, a reflected wireless link (r-WINE) may form a reflection path even in a NLoS environment by using an IRS unit, thereby providing a virtual line-of-sight propagation path between a transmitting wireless transceiver and a receiving wireless transceiver.

When locations of the wireless transceivers and the IRS units are fixed and deterministic, channel state information for a transceiver-to-IRS segment and an IRS-to-transceiver segment may be obtained relatively easily. In addition, for each pair of a transmitting wireless transceiver and a receiving wireless transceiver, a candidate list of IRS units (or panels) that provide a strong reflected signal may be derived. When an inter-rack data-sharing request occurs, a best-effort panel selection procedure may be applied to select an IRS unit so as to maximize throughput within a range that satisfies a non-overlapping panel assignment constraint (i.e., a constraint that prevents the same IRS unit from being assigned to two or more reflected links simultaneously within the same control interval).

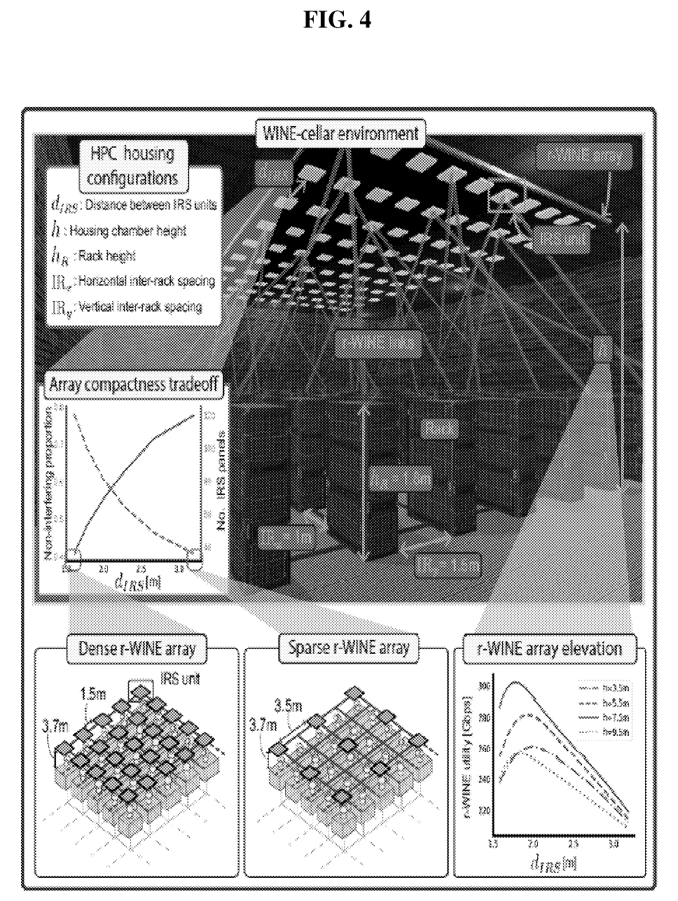

In a dense wireless connectivity environment, system configuration elements such as a housing size, a rack arrangement, and an IRS-unit density may collectively affect the utility of r-WINE. According to an embodiment of the present disclosure, by prototyping an HPC system in the digital twin environment and performing virtual simulations, the system configuration elements may be adjusted (tuned). FIG. 4 is a diagram illustrating an example of a housing configuration in a digital twin environment and a resulting utility of a reflected wireless link, according to an embodiment of the present disclosure.

For example, a virtual HPC system prototype in the digital twin environment may be configured to accommodate a 10 × 10 rack layout in a 20 m × 20 m machine room space. In this case, a regular spacing d_{IRS} between IRS units installed on a ceiling may introduce a trade-off between the number of available IRS units that can be configured simultaneously (referred to herein as the number of r-WINE links) and interference-management performance. The system may, for example, compare and analyze r-WINE link utilities in a ceiling-mounted planar IRS array of 18 m × 18 m while varying d_{IRS} within a range of 1.5 m to 3.5 m. Since the IRS units can be manufactured in a compact size, for example, 121 IRS units may be accommodated when d_{IRS} = 1.5 m. When an area of the IRS array is fixed, d_{IRS} determines the number of installed IRS units, which may determine an upper limit of the number of r-WINE links that can be configured simultaneously.

The system may configure a maximum number of r-WINE links using bandwidth and channel propagation parameters set in a link budget analysis, and then perform ray tracing assuming a 3 dB beamwidth corresponding to an antenna gain. In addition, the system may track beam overlaps and intersections to calculate a proportion of r-WINE links subject to mutual interference. In general, a dense IRS array (small d_{IRS}) increases IRS panel availability and thus enhances a degree of freedom in link configuration, but may be more susceptible to interference because a plurality of beams are formed simultaneously in a limited space. Conversely, a sparse IRS array (large d_{IRS}) may reduce a likelihood of beam collisions, but may limit a capability of configuring simultaneous links due to a reduced number of available IRS units.

The system may compute an average throughput of remaining links excluding links impaired by beam collisions. When d_{IRS} is excessively small or excessively large, excessive interference or a shortage of IRS units may occur, respectively, which suggests that an optimal d_{IRS} exists for a given housing configuration. Further, the optimal d_{IRS} may vary depending on a machine-room height h. A small h shortens a propagation distance to the ceiling, which is advantageous in preserving directionality and energy of r-WINE signals, but may increase a likelihood of beam collisions due to a constrained space. As h increases, interference management becomes relatively easier and thus the optimal d_{IRS} may become smaller; however, an excessively large h (e.g., 9.5 m) may degrade an overall utility due to a reduced signal strength. By way of example, an average r-WINE throughput of 300 Gbps may be achieved with a configuration of h = 7.5 m and d_{IRS} = 1.8 m, which supports feasibility of interference management and integration into an HPC system.

The system according to an embodiment of the present disclosure may jointly coordinate a straight wireless link (s-WINE), a reflected wireless link (r-WINE), and a wired link, thereby transforming a physically fixed network structure into a logical interconnection structure suitable for a workflow. Further, applicability of wireless links may be extended to interconnect topologies widely adopted in the digital-twin environment. For example, wireless links may reinforce upper-tier bandwidth in a fat-tree topology, or may provide direct inter-group connections in a Dragonfly topology to reduce transmission latency. In a baseline wired interconnect structure, the straight wireless link (s-WINE) and the reflected wireless link (r-WINE) may enable direct communication between a rack pair separated by multiple hops along a wired path, thereby reducing a hop count and an end-to-end latency. By way of example, a wired link may have a single-hop latency on the order of 0.6 μs.

In other words, the digital twin engine (340) may be configured to generate, in the digital-twin environment, interconnection candidate configurations (e.g., virtual candidate communication link configurations) that include (i) a LoS straight wireless communication link between wireless transceivers, (ii) a NLoS reflected wireless communication link using an IRS unit, and (iii) path selection and/or traffic distribution for wired links between racks, and then evaluate, via virtual simulations for the respective candidates, communication performance and workflow satisfaction, thereby deriving an optimal interconnection configuration suitable for an application workflow.

Accordingly, the digital twin engine (340) may, while assuming physically fixed placements of racks/wirings/devices, determine, in a virtual environment, link selection, paths (routing), and resource-allocation policies to satisfy an application’s task graph and communication requirements, thereby providing a result of mapping physical network connectivity to a logical interconnection topology.

In more detail, the digital twin engine (340) may update a link state of the digital twin environment based on link quality measurements collected from the telemetry module (330). That is, the digital twin engine (340) may maintain the link state in the digital twin environment close to a real environment by calibrating at least one of channel-model parameters, interference-model parameters, and reflection-model parameters (e.g., an IRS reflection-coefficient/phase model), using the link quality measurements and preset environment/placement information.

In addition, the digital twin engine (340) may generate, in the digital twin environment, a distribution plan that allocates application jobs on a per-cluster basis and assigns distributed tasks to compute nodes within each cluster. For example, the digital twin engine (340) may derive, from the distribution plan, a traffic matrix or communication requirements indicating inter-node data-exchange demands (e.g., traffic volume, communication frequency, and latency requirements), and may generate a plurality of virtual candidate communication-link configurations to satisfy the communication requirements. In this case, each virtual candidate communication-link configuration may include a LoS direct communication link between wireless transceivers and/or a NLoS reflected communication link using the IRS unit (320).

For example, the digital twin engine (340) may generate a task graph from the distribution plan or receive a task graph from an external source, and may jointly optimize selection of the distribution plan and an optimal communication-link configuration based on task precedence relationships in the task graph and inter-task communication volume or communication frequency. For example, the digital twin engine (340) may adjust the distribution plan together with the link configuration such that a low-latency link is preferentially assigned to task dependencies expected to cause communication bottlenecks or to task pairs having a high communication frequency.

The digital twin engine (340) may perform virtual simulations for each of the virtual candidate communication-link configurations to predict link performance, and may select an optimal communication-link configuration based on constraint conditions and an objective function. Here, each virtual candidate communication-link configuration may include: (i) a combination of a transmitting wireless transceiver and a receiving wireless transceiver; (ii) a path of an LoS direct communication link or an NLoS reflected communication link set for the combination; (iii) wireless-transceiver parameters (e.g., beam direction, beamwidth, antenna-array weights, transmit power, center frequency, bandwidth, and a modulation and coding scheme (MCS)); and (iv) reflection parameters of the IRS unit (320) (e.g., unit-cell-level phase and/or amplitude settings).

The virtual simulation may be a process of, for each of the virtual candidate communication-link configurations, assuming that the wireless-transceiver parameters and the reflection parameters are applied, and calculating and predicting link performance metrics based on a channel model, an interference model, and a reflection model included in the digital twin environment. For example, the link performance metrics may include at least one of latency, tail latency, throughput, packet error rate, signal-to-noise ratio, and congestion, and the virtual simulation may perform prediction for comparing and evaluating performance of the candidate configurations without performing actual data transmission.

In addition, the constraint conditions may include an interference threshold, a limit on the number of simultaneous links, limitations on available resources of the wireless transceivers and the IRS units, a non-overlapping panel assignment constraint (a constraint such that, within a same control interval, a same IRS unit is not simultaneously assigned to two or more reflected links), and an upper bound on the number of links that can be simultaneously served per IRS unit. Further, the objective function may include at least one of latency, tail latency, congestion, throughput, signal-to-noise ratio, packet error rate, energy consumption, and a wireless-link reconfiguration cost. The digital twin engine (340) may calculate and output wireless-transceiver parameters (e.g., transmit power, center frequency, bandwidth, MCS, antenna-array weights, beam direction, and beamwidth) and reflection parameters of the IRS unit (320) (e.g., unit-cell-level phase/amplitude settings) corresponding to the optimal communication-link configuration.

In addition, the digital twin engine (340) may receive event information including maintenance work in the machine room space, cage opening/closing, cage temperature, placement of movable equipment, and occurrence of temporary obstacles, and may apply a penalty to a virtual candidate communication-link configuration for which link blockage or performance degradation is expected according to the event information, thereby causing the optimal communication-link configuration to be selected. For example, the digital twin engine (340) may increase a weight (penalty) for an LoS direct communication link or an NLoS reflected communication link associated with an event-occurrence region such that the objective-function value becomes unfavorable, thereby allowing a candidate configuration that avoids the event impact to be preferentially selected.

In addition, the digital twin engine (340) may calculate an error between the link quality measurements collected from the telemetry module (330) and the link performance metrics predicted in the virtual simulation, and may update the link state of the digital twin environment by calibrating at least one of channel-model parameters, interference-model parameters, and reflection-model parameters in the digital twin environment such that the error is minimized. Accordingly, even when actual link characteristics change due to passage of time, environmental changes, or changes in equipment conditions, the digital twin engine (340) may perform online calibration to maintain prediction accuracy.

Depending on an implementation, when the link quality measurements collected from the telemetry module (330) after applying the optimal communication-link configuration fall below a preset performance criterion or when a link disconnection event is detected, the digital twin engine (340) may select a backup communication-link configuration stored in advance or a next-best communication-link configuration among the virtual candidate communication-link configurations, and provide the selected configuration to the network controller (350), thereby enabling a fast switching (fallback or hand-over) between an LoS direct communication link and an NLoS reflected communication link. In this case, the backup communication-link configuration may be stored as a plurality of preselected candidate link configurations, and the next-best communication-link configuration may be a candidate having a second-best objective-function value or a candidate having a high priority among candidates satisfying a specified performance criterion.

Alternatively, the digital twin engine (340) may further include a policy generation unit for deriving an interconnection configuration based on the link-state update and the virtual simulation results. The policy generation unit may receive, as inputs, communication requirements derived from a workload distribution plan and job mapping results, and link quality measurements from the telemetry module, and may calculate a policy that outputs wireless transceiver parameters (e.g., beam direction/beamwidth/array weights, transmit power, center frequency, bandwidth, and MCS) and/or reflection parameters of the IRS units (e.g., unit-cell-level phase and/or amplitude). In this case, the policy generation unit may compute the policy by solving an optimization problem with a defined objective function and constraints.

In another example, the policy generation unit may calculate the policy using a reinforcement-learning-based policy model that is trained through interaction within the digital twin environment without relying on supervised ground-truth data. For example, a state of the policy model may include link quality measurements, a digital-twin link state (channel/interference/reflection model parameters), communication dependencies in a job graph, a traffic matrix, rack/transceiver/IRS placement information, and environmental event information (maintenance work, cage opening/closing, mobile equipment, etc.). An action of the policy model may include at least one of: (i) selecting an LoS direct link or an NLoS reflected link, (ii) selecting a link pair (transmitter - receiver pairing) and an IRS panel, (iii) adjusting beam/transmit power/frequency/bandwidth/MCS/array weights, and (iv) adjusting IRS phase/amplitude settings. A reward may be defined to reflect performance improvements such as reduced latency and tail latency, increased throughput, reduced congestion, and reduced packet error rate as positive terms, and to reflect increased interference, increased energy consumption, and increased link reconfiguration cost as negative terms.

In addition, the policy generation unit may learn a link-state representation (embedding) and/or a traffic-pattern representation through self-supervised or unsupervised learning, and may be configured to use the learned representation as an input feature for the reinforcement-learning policy model, or to cluster workload/traffic patterns and select different policies for respective workload types. For example, based on an unsupervised clustering result, the policy generation unit may distinguish between a workload mainly involving local communications and a workload mainly involving global communications, and may apply, in the former case, a link-deployment policy favorable to forming a dispersed state, and, in the latter case, a link-deployment policy favorable to forming a cohesive state centered on hub racks.

The network controller (350) may adjust the plurality of wireless transceivers (310) and the plurality of IRS units (320) based on the parameters output from the digital twin engine (340). For example, for an LoS direct communication link, the network controller (350) may adjust at least one of transmit power, center frequency, bandwidth, modulation and coding scheme (MCS), antenna array weights, beam direction, and beamwidth of the wireless transceivers (310), and, for an NLoS reflected communication link, the network controller (350) may adjust reflection parameters of the IRS units (320), including unit-cell-level phase and/or amplitude settings.

In addition, according to an embodiment of the present disclosure, the digital twin engine (340) and the network controller (350) may operate a multi-layer control period. For example, in a first control period, beam parameters may be finely adjusted on a microsecond (us) to millisecond (ms) timescale, and, in a second control period, a communication-link configuration may be rearranged on a minute-level timescale. Further, in a third control period, on an hourly or daily timescale, the digital twin engine (340) may update constraints and/or an objective function applied to the optimization by reflecting cooling constraints or environmental conditions.

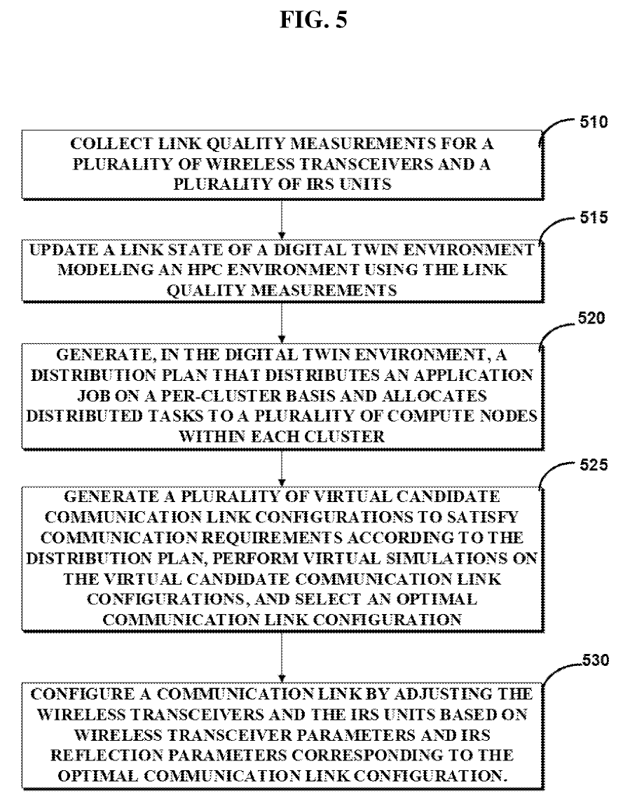

FIG. 5 is a flowchart illustrating a method of optimizing a wireless interconnection network in a high-performance computing environment according to an embodiment of the present disclosure.

In step 510, the wireless interconnection network system collects link-quality measurements for a plurality of wireless transceivers and a plurality of intelligent reconfigurable reflecting surface (IRS) units attached in a machine room space.

More specifically, the telemetry module (330) may collect link-quality measurements including at least one of a signal-to-noise ratio (SNR), a received signal strength indicator (RSSI), a packet error rate (PER), a number of retransmissions, latency, and throughput. In addition, the link-quality measurements may be collected for each of a LoS direct link and/or a NLoS reflected link.

In step 515, the wireless interconnection network system updates a link state of a digital twin environment modeling the high-performance computing environment by using the collected link-quality measurements. Hereinafter, it is assumed that the high-performance computing environment is modeled as illustrated in FIG. 4.

For example, the digital twin engine (340) may calculate an error between actual measurements and link-performance metrics predicted in the digital twin environment, and may maintain the link state in the digital twin environment to be close to the actual environment by correcting channel-model parameters, interference-model parameters, and reflection-model parameters (for example, an IRS reflection model) such that the error is reduced.

In step 520, the wireless interconnection network system generates, in the digital twin environment, a distribution plan that distributes an application job on a per-cluster basis and assigns distributed workloads to a plurality of compute nodes within each cluster. The job distribution on a per-cluster basis may be determined differently based on, for example, a scale and characteristics of the application job. The digital twin engine may divide a job distributed to each cluster into individual compute units (distributed workloads) and may independently distribute the distributed workloads to the respective compute nodes. Here, a workload may be a detailed processing unit of a job and may include, for example, computation, data processing, and analysis tasks. Accordingly, the digital twin engine may allocate resources required for an entire cluster and then distribute the workloads to the compute nodes. Such workload distribution to the compute nodes may be performed such that each compute node can achieve optimized performance. For example, more detailed tasks may be assigned to a compute node having higher computing capability, and tasks imposing a lower memory burden may be assigned to a compute node having limited memory resources.

In step 525, the wireless interconnection network system generates a plurality of virtual candidate communication-link configurations to satisfy communication requirements according to the distribution plan, and performs virtual simulations for the respective virtual candidate communication-link configurations to predict and evaluate link performance.

For example, distributed workloads may undergo job mapping in consideration of a node layout and a physical structure within each cluster, and wireless links may be configured to satisfy topology requirements of the cluster (for example, providing short paths between remote nodes, bypassing congested segments, reducing tail latency, and minimizing synchronization delays). Accordingly, the digital twin engine may derive a traffic matrix or communication requirements (for example, a communication volume between node pairs, a communication frequency, a latency limit, and a throughput target) from the distribution plan and the job-mapping result, and may generate the virtual candidate communication-link configurations to satisfy the derived requirements.

As described above, each virtual candidate communication-link configuration may include (i) a LoS direct communication-link configuration that supports high-speed data transmission between wireless transceivers and (ii) a NLoS reflective communication-link configuration that supports data transmission by forming a reflective path via an intelligent reconfigurable reflecting surface unit.

According to an embodiment of the present disclosure, the system may utilize a high-frequency band such as a terahertz band to maximize transmission performance and may dynamically adjust wireless links so that signals reach an intended destination by optimizing a reflection path of the IRS unit. Accordingly, propagation loss in an indoor environment may be reduced and link efficiency may be improved.

The virtual candidate communication-link configuration may include: (i) a combination of a transmitting-side wireless transceiver and a receiving-side wireless transceiver; (ii) a path of an LoS direct communication link and a path of an NLoS reflective communication link using an IRS unit, which are set for the combination; (iii) wireless transceiver parameters (for example, a beam direction, a beamwidth, antenna-array weights, transmit power, a center frequency, a bandwidth, and a MCS); and (iv) reflection parameters of the IRS unit (for example, at least one of a unit-cell-level phase setting and a unit-cell-level amplitude setting).

The digital twin engine may perform, for each of the virtual candidate communication-link configurations, a virtual simulation that calculates and predicts link performance metrics (for example, latency, tail latency, throughput, packet error rate, signal-to-noise ratio, and congestion) based on a channel model, an interference model, and a reflection model. Further, the digital twin engine may evaluate the candidate configurations in consideration of constraints including an interference threshold, a limit on the number of simultaneous links, an available-resource limit of the wireless transceivers and the IRS units, a non-overlapping panel-allocation constraint (a constraint that, within the same control interval, a same IRS unit is not simultaneously allocated to two or more reflective links), and an upper bound on the number of links that can be simultaneously served per IRS unit, and may select a communication-link configuration that optimizes an objective function (e.g., latency, tail latency, throughput, packet error rate, signal-to-noise ratio, energy consumption, link reconfiguration cost, etc.).

In the high-performance computing system, each compute node may independently perform computation. Accordingly, the system may maximize computational efficiency by monitoring, in real time, an operational state of each compute node and wireless-link efficiency and adjusting a wireless-link direction and a beamforming direction. The high-performance computing system may continuously exchange necessary data via wireless communication links so that distributed computation tasks assigned to the compute nodes are smoothly performed, and may monitor, in real time, communications through the wireless communication links between the compute nodes so as to adjust, in real time, the wireless-link direction and the beamforming direction.

Upon completion of computation at the compute nodes, the high-performance computing system may transmit computation results of the respective compute nodes to a central node (a data aggregation device) for aggregation, and may reduce an aggregation time and promptly obtain final computation results by transmitting data in parallel based on high-bandwidth wireless links. In this case, the high-performance computing system may configure multi-path wireless links and adjust the wireless links such that the respective compute nodes simultaneously transmit data (computation results), thereby enabling smooth data aggregation.

In addition, when some of the tasks distributed to the compute nodes are not completed, the high-performance computing system may distribute incomplete tasks on a cluster basis, analyze progress of the incomplete tasks, and monitor the tasks so that the tasks are completed through necessary data transmission and redistribution processes.

When all tasks are completed, the high-performance computing system may collect results to the central node to perform final processing. Thereafter, when a new task is assigned, the high-performance computing system may return to an initial stage to prepare for processing the new task. In this process, performance of the wireless links may be evaluated, and, if necessary, a link configuration may be optimized so that higher efficiency is expected in processing the subsequent task.

As described above, operations of the high-performance computing system, including a task distribution plan, distributed workload execution for each cluster, collection and aggregation of results of tasks distributed to the compute nodes, and a redistribution process, may be virtually simulated in the digital twin environment, and a wireless communication link state and a data transmission rate for optimizing performance of the virtual high-performance computing system may be monitored in real time.

Depending on implementation, the above-described generation of the task distribution plan, job mapping, and policy computation may be performed in conjunction with a resource management layer of the high-performance computing system. For example, the digital twin engine may interwork with a container orchestrator (e.g., Kubernetes) and/or a hypervisor (a virtual machine monitor) to receive: (i) per-node placement states of containers/virtual machines, resource allocations (CPU/GPU/memory), and network namespace/virtual switch configurations, (ii) workload scheduling results and migration events, and (iii) service chain or communication flow policy information. In addition, the digital twin engine may request the container orchestrator to perform workload reallocation (e.g., pod rescheduling, affinity/anti-affinity policy updates) or to apply traffic engineering policies, or may request the hypervisor to adjust at least one of a virtual NIC, SR-IOV, a vSwitch path, and RDMA-related settings, so as to correspond to the derived optimal interconnection configuration. Accordingly, the system of the present disclosure may perform closed-loop optimization linking logical workload placement and physical wired/wireless link and path configurations, thereby dynamically operating the high-performance computing environment in a manner satisfying workflow requirements (latency/tail latency/throughput/congestion).

The wireless interconnection network system may perform an automatic recovery procedure in an unexpected error condition or a failure occurrence to enhance system stability and maintain optimal performance. The digital twin environment may continuously receive feedback on a link state and adjust a link configuration, thereby playing an important role in maintaining an optimal communication environment.

In other words, the digital twin engine may perform a virtual simulation for each virtual candidate communication link configuration to predict link performance. Here, the virtual simulation may be a process of calculating and predicting link performance metrics based on channel/interference/reflection models of the digital twin environment, without performing actual data transmission, while assuming that parameters corresponding to the candidate configuration have been applied.

In addition, the digital twin engine may evaluate the candidate configurations based on constraints and an objective function. For example, the constraints may include: (i) an interference threshold, (ii) a limitation on the number of concurrent links and an availability constraint on resources of the wireless transceivers and the IRS units, (iii) a non-overlapping panel assignment constraint (a constraint that, within the same control interval, the same IRS unit is not assigned simultaneously to two or more reflection links), and (iv) an upper limit on the number of links that each IRS unit can concurrently serve. In addition, the objective function may include at least one of latency, tail latency, congestion, signal-to-noise ratio, packet error rate, throughput, energy consumption, and a link reconfiguration cost.

Further, depending on implementation, the digital twin engine may receive event information including maintenance work in the machine room space, cage opening/closing, cage temperature, placement of mobile equipment, and occurrence of temporary obstacles, and may assign a penalty to a candidate communication link configuration expected to experience link blockage or performance degradation according to the event information, and reflect the penalty in the candidate evaluation.

In step 530, the wireless interconnection network system selects an optimal communication link configuration based on the evaluation result, and calculates and outputs wireless transceiver parameters and reflection parameters of the IRS units corresponding to the selected optimal communication link configuration. The network controller may configure communication links by adjusting the plurality of wireless transceivers and the plurality of IRS units based on the output parameters. For example, when the optimal communication link configuration includes a LoS direct link, the network controller may adjust at least one of transmit power, a center frequency, bandwidth, an MCS, antenna array weights, a beam direction, and a beamwidth. When the optimal communication link configuration includes an NLoS reflection link, the network controller may adjust reflection parameters including phase and/or amplitude settings on a unit-cell basis of the IRS units.

As described above, the wireless interconnection network system may bidirectionally interwork a physical high-performance computing system and a virtual high-performance computing system modeled in a digital twin environment, thereby (i) reflecting telemetry-based link quality measurements in updating link states of the digital twin environment, and (ii) applying, to the physical high-performance computing system, the optimal communication link configuration and parameters derived in the digital twin environment, so as to implement closed-loop control in which wired/wireless interconnection configurations are repeatedly optimized according to workload changes and environmental changes.

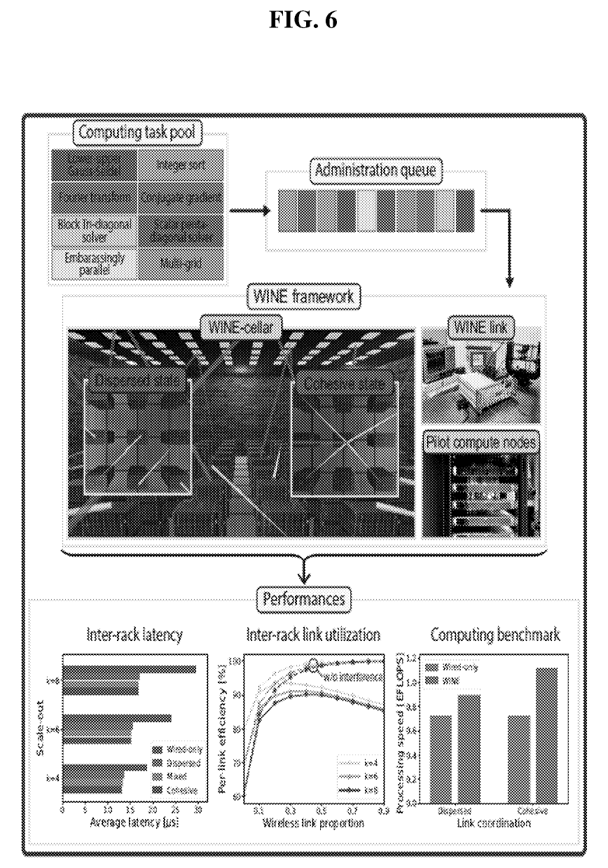

FIG. 6 is a diagram illustrating, together with a wireless-link testbed and a pilot compute-node platform, a process of evaluating link-adjustment results and performance of a virtual high-performance computing (HPC) system in a digital-twin environment.

Referring to FIG. 6, the upper portion illustrates a configuration in which a plurality of representative HPC benchmark workloads (e.g., lower-upper Gauss-Seidel, Fourier transform, integer sort, etc.) included in a computing task pool are sequentially injected by an administration queue.

The middle portion illustrates an example in which the digital twin engine analyzes inter-rack communication traffic patterns and deploys and adjusts a direct wireless link (s-WINE) and a reflective wireless link (r-WINE) to reconfigure an interconnection structure. In this case, the interconnection structure formed as a result of link adjustment may be classified into a dispersed state, a cohesive state, or a mixed state according to a distribution of the numbers of neighbor connections and link-deployment characteristics. In addition, the right portion illustrates a wireless-link testbed (WINE link) and pilot compute nodes for verifying real-world applicability of the digital-twin results.

Because representative HPC workloads have different inter-rack data-sharing patterns, communication latency and link utilization efficiency may vary depending on a link-adjustment policy. For example, a lower-upper Gauss-Seidel (Gauss-Seidel) class workload may involve relatively frequent data exchanges mainly between adjacent racks; thus, a dispersed state that strengthens local connectivity by reinforcing wireless links between adjacent racks may be advantageous. In contrast, a workload such as a Fourier transform or an integer sort, which references information distributed across all racks, may involve frequent communications between distant racks, such that tail latency caused by a network critical path is likely to become a bottleneck. In this case, by intensively deploying wireless links around hub racks connected to a large number of neighbors to form a cohesive state, a path length (number of hops) between a pair of distant non-neighbor racks may be shortened, thereby reducing latency.

In the lower portion of FIG. 6, performance results according to the link-adjustment outcomes are exemplarily presented. First, an average inter-rack latency may be reduced compared to a wired-only baseline architecture as the number of hops required for inter-rack communications decreases through wireless-link deployment, and such latency reduction may be particularly pronounced in a cohesive state. Second, an inter-rack link utilization may be improved as direct connections that bypass congested segments are provided. However, when a ratio of wireless connections excessively increases, mutual interference may increase and thereby partially degrade a data rate; nevertheless, even under a moderate interference condition, a link utilization higher than that of the wired-only baseline architecture may be maintained. Third, a computing benchmark using a pilot compute-node platform exemplarily shows that parallel-processing performance may be improved as the average number of hops decreases due to wireless-link deployment. For example, when a wireless interconnection is deployed to form a dispersed state and a cohesive state in a pilot system of a certain scale, the average number of hops may decrease and, accordingly, benchmark throughput performance may be improved.

The apparatus and method according to embodiments of the present disclosure may be implemented in the form of program instructions executable through various computer means and may be recorded on a computer-readable medium. The computer-readable medium may include program instructions, data files, data structures, or combinations thereof. The program instructions recorded on the computer-readable medium may be those specially designed and configured for the present disclosure, or those known to and available to persons having ordinary skill in the field of computer software. Examples of computer-readable recording media include magnetic media such as hard disks, floppy disks, and magnetic tapes; optical recording media such as CD-ROMs and DVDs; magneto-optical media such as floptical disks; and hardware devices specially configured to store and execute program instructions, such as ROM, RAM, flash memory, and the like. Examples of program instructions include not only machine-language code produced by a compiler but also high-level language code that can be executed by a computer using an interpreter or the like.

The hardware device may be configured to operate as one or more software modules to perform the operation of the present disclosure, and vice versa.

The present disclosure was described above focusing on the embodiments thereof. It would be understood by those skilled in the art that the present disclosure may be implemented in a modified form without departing from the scope of the present disclosure. Therefore, the disclosed embodiments should be considered in terms of explaining, not limiting. The scope of the present disclosure is shown in the claims, not in the above description, and all differences within an equivalent range should be construed as being included in the present disclosure.

What is claimed is:

1. A wireless interconnection network system comprising:
a plurality of wireless transceivers attached to at least one of a plurality of racks and a plurality of compute nodes, wherein the plurality of racks are disposed in a machine room space and accommodate the plurality of compute nodes for high-performance computing;
a plurality of intelligent reconfigurable reflecting surface units disposed on at least one of a ceiling of the machine room space, the racks, and a wall surface;
a telemetry module configured to collect link-quality measurements for the plurality of wireless transceivers and the plurality of intelligent reconfigurable reflecting surface units;
a digital twin engine configured to update a link state of a digital twin environment modeling the high-performance computing environment based on the collected link-quality measurements, generate virtual candidate communication-link configurations to satisfy communication requirements according to a distribution plan for an application task in the digital twin environment, perform virtual simulations on the virtual candidate communication-link configurations to select an optimal communication-link configuration, and output wireless-transceiver parameters and parameters of the intelligent reconfigurable reflecting surface units corresponding to the selected optimal communication-link configuration; and
a network controller configured to adjust the plurality of wireless transceivers and the plurality of intelligent reconfigurable reflecting surface units based on the parameters output from the digital twin engine,
wherein each of the plurality of virtual candidate communication link configurations includes at least one of (i) a line-of-sight (LoS) direct communication link between wireless transceivers or (ii) a non-line-of-sight (NLoS) reflective communication link using the intelligent reconfigurable reflecting surface units.

2. The wireless interconnection network system of claim 1,
wherein the digital twin engine is configured to:
generate a distribution plan by distributing the application tasks on a per-cluster basis and assigning distributed tasks to the plurality of compute nodes within each cluster; and
based on the distribution plan, generate a plurality of virtual candidate communication-link configurations based on a traffic matrix or communication requirements representing inter-node data-exchange demands between the compute nodes,
wherein each of the virtual candidate communication-link configurations includes a combination of a transmitting-side wireless transceiver and a receiving-side wireless transceiver among the plurality of wireless transceivers.

3. The wireless interconnection network system of claim 2,
wherein the digital twin engine is configured to:
perform a virtual simulation on the virtual candidate communication-link configurations under constraint conditions, evaluate the virtual candidate communication-link configurations based on an objective function, and select the optimal communication-link configuration,
wherein the constraint conditions include:
(i) an interference threshold,
(ii) a limit on a number of simultaneously active links and a limit on available resources of the wireless transceivers and the intelligent reconfigurable reflecting surface units,
(iii) a non-overlapping panel assignment constraint that prevents, within a same control interval, a same intelligent reconfigurable reflecting surface unit from being simultaneously assigned to two or more non-line-of-sight (NLoS) reflected communication links, and
(iv) an upper limit on a number of links that are simultaneously serviceable by each intelligent reconfigurable reflecting surface unit, and
wherein the objective function includes at least one of latency, tail latency, congestion, signal-to-noise ratio (SNR), packet error rate, throughput, energy consumption, and a wireless-link reconfiguration cost.

4. The wireless interconnection network system of claim 2,
wherein the network controller is configured to:
when the optimal communication-link configuration includes a line-of-sight (LoS) direct communication link, adjust, based on the wireless transceiver parameters, at least one of transmit power, a center frequency, bandwidth, a modulation and coding scheme (MCS), antenna-array weights, a beam direction, and a beamwidth; and
when the optimal communication-link configuration includes a non-line-of-sight (NLoS) reflected communication link, adjust a reflection parameter including at least one of a unit-cell-level phase setting and a unit-cell-level amplitude setting of the intelligent reconfigurable reflecting surface unit.

5. The wireless interconnection network system of claim 2,
wherein the line-of-sight (LoS) direct communication link and the non-line-of-sight (NLoS) reflected communication link are formed in at least one frequency band selected from a millimeter-wave (mmWave) band, a sub-terahertz (sub-THz) band, a terahertz (THz) band, and a free-space optical (FSO) band,
wherein, when the at least one frequency band includes the free-space optical (FSO) band, the intelligent reconfigurable reflecting surface unit includes an optical reflective metasurface device, and
wherein the network controller is configured to dynamically control angles of the wireless transceiver and the optical reflective metasurface device for optical path alignment.

6. The wireless interconnection network system of claim 3,
wherein the digital twin engine and the network controller operate control cycles in a multi-layer manner,
wherein, in a first control cycle, beam parameters are finely adjusted in units of microseconds (us) to milliseconds (ms),
wherein, in a second control cycle, a communication link configuration is reconfigured in units of minutes, and
wherein, in a third control cycle, the constraints and the objective function are updated in units of hours or days by reflecting a cooling constraint or an environmental state.

7. The wireless interconnection network system of claim 3,
wherein the digital twin engine receives event information including maintenance work in the machine room space, opening/closing of a cage, a cage temperature, placement of mobile equipment, and occurrence of a temporary obstacle, and
selects the optimal communication link configuration by applying a penalty to a candidate communication link configuration in which link blockage or performance degradation is expected according to the event information.

8. The wireless interconnection network system of claim 1,
wherein the digital twin engine calculates an error between link quality measurements collected from the telemetry module and link performance metrics predicted in the virtual simulation, and
updates a link state of the digital twin environment by calibrating at least one of a channel model parameter, an interference model parameter, and a reflection model parameter in the digital twin environment such that the error is minimized,
wherein the link performance metrics include at least one of a signal-to-noise ratio, a packet error rate, a throughput, and a latency.

9. The wireless interconnection network system of claim 1,
wherein the digital twin engine generates a task graph from the distribution plan or receives the task graph, and
jointly optimizes the distribution plan and selection of the optimal communication link configuration based on (i) precedence relationships between tasks and (ii) at least one of an inter-task communication volume and an inter-task communication frequency, using the task graph.

10. The wireless interconnection network system of claim 2,
wherein the digital twin engine, when, after application of the optimal communication link configuration, (i) link quality measurements collected from the telemetry module fail to meet a preset performance criterion or (ii) a link disconnection event is detected,
selects a backup communication link configuration stored in advance or a next-best communication link configuration among the virtual candidate communication link configurations, and provides the selected configuration to the network controller,
thereby enabling a fast switch (fallback or hand-over) between the line-of-sight (LoS) direct communication link and the non-line-of-sight (NLoS) reflected communication link.

11. The wireless interconnection network system of claim 1,
wherein the digital twin engine:
based on baseline deployment information of the wireless transceivers and the intelligent reconfigurable reflecting surface units, performs beam pre-training for a plurality of beam candidates to generate a beam codebook and a list of link candidates;
estimates, via self-calibration based on at least one of a pilot signal and integrated sensing and communication (ISAC), a beam alignment error and derives a correction value; and
incorporates the correction value as an initial value or a constraint condition for at least one of the wireless transceiver parameters and the intelligent reconfigurable reflecting surface unit parameters.

12. A method for optimizing a wireless interconnection network in a high-performance computing (HPC) environment, the method comprising:
(a) collecting link quality measurements for a plurality of compute nodes accommodated in a plurality of racks in a machine room space, a plurality of wireless transceivers attached to the racks, and a plurality of intelligent reconfigurable reflecting surface units disposed on at least one of a ceiling of the machine room space, the racks, or a wall surface;
(b) updating, using the link quality measurements, a link state of a digital twin environment that models the HPC environment;
(c) generating, in the digital twin environment, a distribution plan for application tasks, and generating a plurality of virtual candidate communication link configurations to satisfy communication requirements according to the distribution plan;
(d) performing virtual simulation for the virtual candidate communication link configurations to select an optimal communication link configuration, and outputting wireless transceiver parameters and parameters of the intelligent reconfigurable reflecting surface units corresponding to the selected optimal communication link configuration; and
(e) configuring a communication link by adjusting the wireless transceivers and the intelligent reconfigurable reflecting surface units based on the output parameters,
wherein each of the virtual candidate communication link configurations includes at least one of (i) a line-of-sight (LoS) direct communication link between wireless transceivers or (ii) a non-line-of-sight (NLoS) reflected communication link using the intelligent reconfigurable reflecting surface units.

13. The method of claim 12,
wherein step (d) comprises:
under constraint conditions, performing the virtual simulation for each of the virtual candidate communication link configurations to evaluate the virtual candidate communication link configurations,
wherein the constraint conditions include:
(i) an interference threshold,
(ii) a limit on a number of simultaneous links and a limit on available resources of the wireless transceivers and the intelligent reconfigurable reflecting surface units,
(iii) a non-overlapping panel assignment constraint that prevents, in a same control interval, a same intelligent reconfigurable reflecting surface unit from being simultaneously assigned to two or more NLoS reflected communication links, and
(iv) an upper limit on a number of simultaneously serviceable links per intelligent reconfigurable reflecting surface unit,
and wherein an objective function includes at least one of latency, tail latency, congestion, a signal-to-noise ratio, a packet error rate, throughput, energy consumption, or a wireless link reconfiguration cost.

14. The method of claim 12,
wherein, after step (e),
when the link quality measurements fall below a preset performance criterion or a link disconnection event is detected, the method further comprises selecting a stored backup communication link configuration or a next-best communication link configuration among the virtual candidate communication link configurations such that a fast switching (fallback or hand-over) is performed between the LoS direct communication link and the NLoS reflected communication link.

15. The method of claim 12,
wherein, before step (b) or in parallel with step (b), the method further comprises:
performing beam pre-training for a plurality of beam candidates based on baseline deployment information of the wireless transceivers and the intelligent reconfigurable reflecting surface units to generate a beam codebook and a list of link candidates;
estimating a beam alignment error and deriving a correction value through self-calibration based on a pilot signal and/or integrated sensing and communication (ISAC); and
incorporating the correction value as an initial value or a constraint condition for the wireless transceiver parameters and/or the intelligent reconfigurable reflecting surface unit parameters.
